(19) United States
(12) Patent Application Publication
(10) Pub. No.: US 2017/0351430 A1
(43) Pub. Date: Dec. 7, 2017

(54) METHOD, APPARATUS, AND SYSTEM FOR CACHE COHERENCY USING A COARSE DIRECTORY

(71) Applicant: Intel Corporation, Santa Clara, CA (US)

(72) Inventors: Robert G. Blankenship, Tacoma, WA (US); Simon C. Steely, JR., Hudson, NH (US); Samantika S. Sury, Westford, MA (US)

(21) Appl. No.: 15/170,050

(22) Filed: Jun. 1, 2016

(51) Int. Cl. G06F 3/06; G06F 12/0808; G06F 12/0815; G06F 12/0811; G06F 12/0842

(52) U.S. Cl. CPC G06F 3/0605; G06F 12/0811; G06F 12/0842; G06F 12/0815; G06F 3/0625; G06F 12/0808; G06F 3/0673; G06F 3/0659; G06F 2212/1028

(57) ABSTRACT

Systems, methods, and apparatuses are directed to requesting access to a memory address; storing an identification of the memory address in a data structure; receiving a first request for access to the memory address, the request comprising a reference to a second processor core; storing the reference to the second processor in the data structure; receiving a second request for access to the memory address, the second request comprising a reference to a third processor core; determining, based on the data structure, that the third processor core is different from the second processor core; and responding to the second request without buffering the second request.

### FIELD

This disclosure pertains to a computing system, and in particular (but not exclusively) to achieving cache coherency when using a coarse directory.

### BACKGROUND

Advances in semi-conductor processing and logic design have permitted an increase in the amount of logic that may be present on integrated circuit devices. As a result, computer system configurations have evolved from a single or multiple integrated circuits in a system to multiple cores that can execute multiple hardware threads in parallel on individual integrated circuits (e.g., individual semiconductor chips). A processor or integrated circuit typically comprises a single physical processor die, where the processor die may include any number of cores that each can execute a respective hardware thread. The ever increasing number of processing elements (e.g., cores)—on integrated circuits enables more tasks to be accomplished in parallel. However, the execution of more threads and tasks put an increased premium on shared resources, such as memory, and the management thereof.

Typically, cache memory includes a memory between a shared system memory and execution units of a processor chip to hold information in a closer proximity to the execution units. In addition, cache is typically smaller in size than a main system memory, which allows for the cache to be constructed from expensive, faster memory, such as Static Random Access Memory (SRAM). Both the proximity to the execution units and the speed allow for caches to provide faster access to data and instructions. Caches are often identified based on their proximity from execution units of a processor. For example, a first-level (L1) cache may be close to execution units residing on the same physical processor chip (e.g., same semiconductor die). Due to the proximity and placement, first level cache is often the smallest and quickest cache. A processor may also hold higher-level or further out caches, such as a second level (L2) cache, which may also reside on the processor chip but be placed between the first level cache and main memory of the computer system. And a third level (L3) cache may be placed on the processor chip or elsewhere in the computer system, such as at a controller hub, between the second level cache and main memory of the computer system.

### BRIEF DESCRIPTION OF THE DRAWINGS

FIG. 1 illustrates an embodiment of a block diagram for a computing system including a multicore processor.

FIG. 2A is a schematic diagram of a set of processor cores a tag directory in accordance with embodiments of the present disclosure.

FIG. 2B is a schematic diagram of an inflight chain of processor cores for cache coherency in accordance with embodiments of the present disclosure.

FIGS. 3A-3E are schematic diagrams of a process flow for a set of cores to establish a chain and maintain cache coherency using a coarse directory in accordance with embodiments of the present disclosure.

FIG. 4 is a process flow diagram for a processor core to respond to a request for access to a memory location without buffering the request in accordance with embodiments of the present disclosure.

FIG. 5 is a process flow diagram for a tag directory to manage cache states in accordance with embodiments of the present disclosure.

FIG. 6 is a diagram illustrating message flows between three processor cores and a home agent in accordance with embodiments of the present disclosure.

FIG. 7 illustrates another embodiment of a block diagram for a computing system Including a processor.

FIG. 8 illustrates an embodiment of a block for a computing system including multiple processor sockets.

FIG. 9 illustrates another embodiment of a block diagram for a computing system.

FIG. 10 illustrates another embodiment of a block diagram for a computing system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

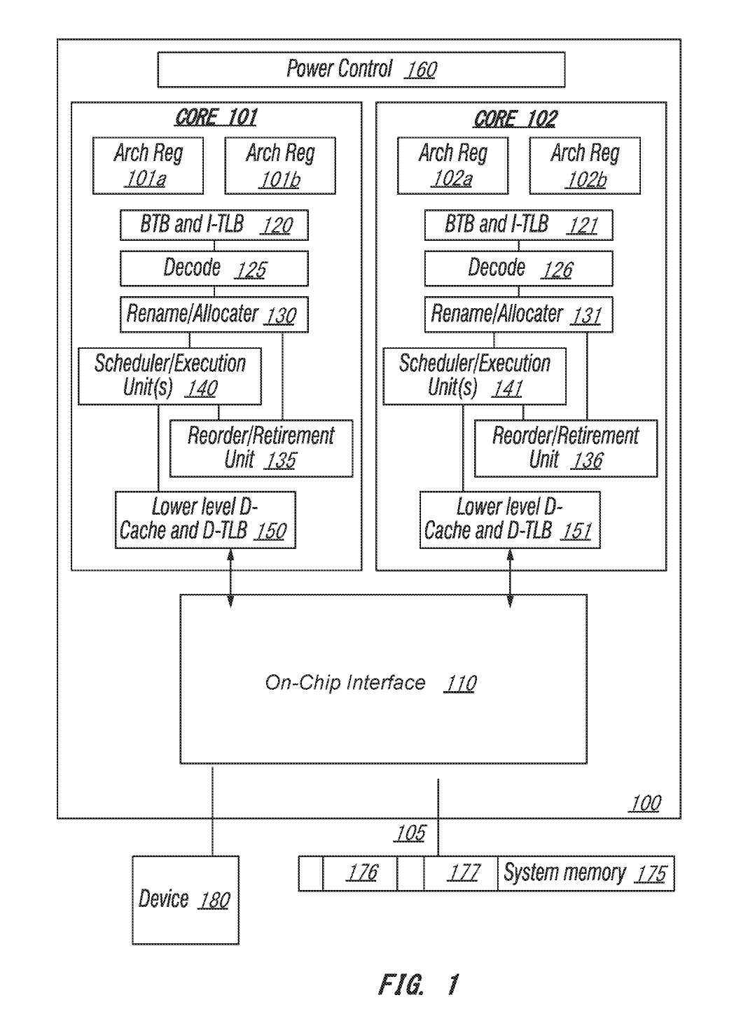

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

A processor may operate on a cache line, e.g., in performing arithmetic or logic functions. A cache-line may generally refer to a block (e.g., a sector) of memory (e.g., a cache) that may be managed as a unit for coherence purposes, for example, cache tags may be maintained on a per-line basis, e.g., in a tag directory. A cache line may be stored in cache memory (e.g., of any level, such as, but not limited to, L3, L2, L3, etc.), system memory, or combinations thereof. Cache memory may be shared by multiple cores of a processor or local (e.g., not shared) to each core of a processor. Cache memory (e.g., a cache) may generally refer to a memory buffer inserted between one or more processors and the bus, for example, to store (e.g., hold) currently active copies of cache lines, (e.g., blocks from system (main) memory). Cache memory may be local to each processor. Additionally or alternatively, cache memory may be shared by multiple processors, e.g., separate from each processor. System memory may be separate from any cache memory, e.g., system memory that is off-die relative to a processor core. Cache line may refer to a 64 byte sized section of memory, e.g., 64 byte granularity. A tag directory entry may be different than the tag entries used in a cache. For example, a tag in the cache may describe the data (e.g., a cache line) at each cache entry. A tag directory may refer to a duplicate bookkeeping structure (e.g., occurring in the un-core) utilized by the cache line coherency logic (e.g., operations) to determine what data is in a cache without having to examine (e.g., access) the cache.

Cache line coherency may generally refer to each cache (e.g., cache memory) and/or system (e.g., main) memory in the coherence domain observing all modifications of that same cache line (e.g., that each instance of that cache line contains the same data). For example, a modification may be said to be observed by a cache when any subsequent read would return the newly (e.g., current) written value.

Cache line coherency logic (e.g., as part of a hardware apparatus or method) may be used to manage and/or resolve conflicts resulting from a number of transactions, for example, a cache line look-up, cache line eviction, cache line fill, and snoop transactions. A snoop may generally refer to the action taken by a module on a transaction when it is not the master that originated the transaction or the repository of last resort for the data, but it still monitors the transaction. A cache (e.g., cache memory) and/or system memory may be snooped to maintain coherence during transactions to a cache line appearing in multiple locations in the cache and/or system memory.

A cache line look-up may involve read and/or read-for-ownership transactions from the processor cores accessing the cache and/or system memory to read or gain ownership of a desired cache line. If the cache line look-up results in a miss in the cache (e.g., cache local to a processor), the request may be allocated to the external request queue, e.g., corresponding to an interface with the system memory. If the cache line look-up results in a hit and the corresponding cache line is not exclusively owned by another core or processor, then the request may be completed and the cache line (e.g., data) returned to the requesting core. Accesses to a particular core from a requesting agent may be reduced by maintaining a tag (e.g., record) in a tag directory of whether another core has exclusive ownership, shared ownership, or no ownership of a requested line of the cache. The tag may be sets of hits in a tag directory (e.g., register) corresponding to the number of cores in a processor and/or processors, where each set of bits may indicate the type of ownership of the requested cache line, if any, for the core and/or processor to which it corresponds. However, the tag may be implemented in other ways without departing from the spirit of this disclosure.

A (e.g., centralized) tag directory may include entries to record the location and/or the status of respective cache lines as they exist throughout the system (e.g., in system memory, cache memory, or otherwise stored in a core and/or processor). For example, the tag directory may include an entry or entries to record which memory locations (e.g., processor caches) have a copy of the cache line (e.g., data), and may further record if any of the memory locations have an updated copy of the cache line (e.g., data).

For example, when a processor (e.g., core of a processor) makes a request to the main memory for a cache line (e.g., data), the tag directory may be consulted to determine where the most recent copy of the cache line (e.g., data) resides. In one embodiment, based on this information the most recent copy of the cache line may be retrieved so that it may be provided to the requesting processor (e.g., the cache memory of the requesting processor). The tag directory may then ne updated to reflect the new status for that cache line. In one embodiment, each cache line read by a processor may be accompanied by a tag directory update (e.g., a write). The tag directory based cache coherency scheme (e.g., logic) may include multiple tag directories, and the tag directories may be arranged in a hierarchy. For example, a hierarchical tag directory structure may include any number of levels. A tag directory may exist for each level of a cache, e.g., a tag directory one (TD1) for a first level of cache, a tag directory two (TD2) for a second level of cache, etc. A tag directory may exist for a grouping of processor cores, e.g., a first tag directory for a plurality (e.g., 8 to 16) cores forming a domain and a second tag directory for a plurality (e.g., 8 to 16) domains each having a plurality of (e.g., 8 to 16) cores.

In one embodiment, conflicting requests to the same cache line (e.g., in multiple memory locations) may be handled by stalling the conflicting request until the data is moved. Stalling requests may not be a scalable approach and may not allow large numbers of processors (e.g., 32 or more processors) to be handled efficiently by the cache line coherency (e.g., logic hardware).

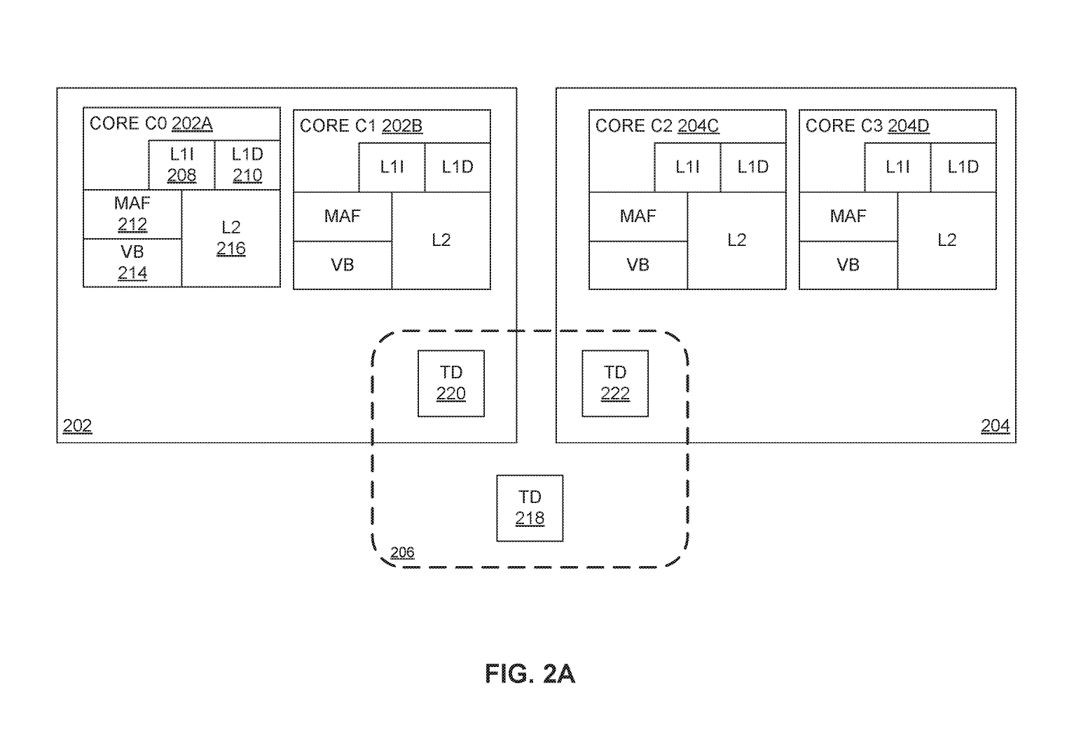

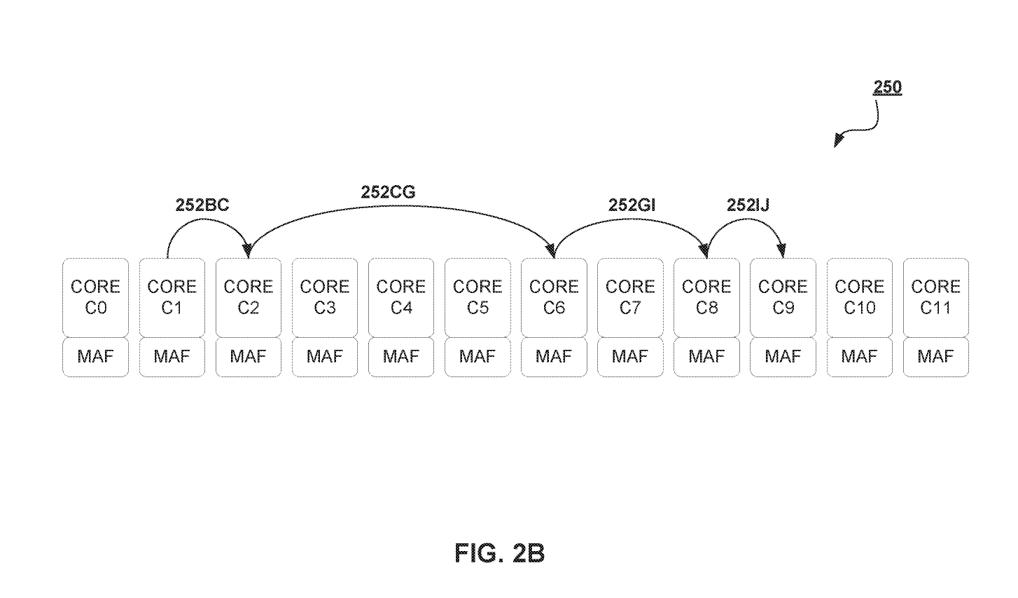

FIG. 2A illustrates an embodiment of multiple processors and tag directories in a cache coherency hierarchy. Cache(s) may be organized in any fashion, for example, as a physically or logically centralized or distributed cache. In one embodiment, a cache may include a physical centralized cache with a similarly centralized tag directory, such as higher level cache. Additionally or alternatively, a tag directory may be physically and/or logically distributed in a physically distributed cache.

In an embodiment, a processor, such as the processors and/or cores illustrated in the Figures, or any other processor, may include one or more caches. FIG. 2A illustrates an embodiment of processors (202, 204) with multiple cores (C0 202A, C1 202B and C2 204C, C3 204D, respectively). A processor may include at least one core and at least one un-core (e.g., 206). In one embodiment, multiple cores (202A, 202B; 204C, 204D) may be a single processor. A core (e.g., 202A, 202B, 204C, 204D) may include components of the processor to execute instructions. An un-core (e.g., 206) may include all logic not in a core. A core (e.g., 202A) may include components such as a level 1 instruction cache (L1I) 208 and a level 1 data cache (L1D) 210. A core may include components such as a missing address file (MAF) 212 (also referred to as an outstanding request buffer (ORB)), victim buffer (VB) 214, and a level 2 cache (L2) 216. An un-core (e.g., 206) may include the tag directories, for example, TD 220, TD 222, and TD 218, the control logic for those tag directories (not shown), and/or the interconnect (not shown) to pass messages (e.g., commands) and data between the cores (e.g., the caches thereof), the system memory, and/or the tag directories. One or more processors, one or more cores, and/or one or more un-cores and their caches may be associated with a domain. In an embodiment illustrated in FIG. 2A, a processor (202 or 204), and its cores, un-cores, and caches, may both be associated into a single domain. A tag directory (TD) 218 may represent data in caches in that single domain. For example, processors (202, 204), and their cores, un-cores, and caches, may each be associated into their own domain, e.g., two domains total. A respective tag directory (TD) (220,222) may represent cache lines (e.g., data) in caches in each domain of processor one 202 and processor two 204. e.g., a level 1 tag directory (TD3). A single tag directory (e.g., TD 218) may represent cache lines (e.g., data) in caches in multiple domains (e.g., of processor one 202 and processor two 204). For example, the tag directory (TD) structure may be a hierarchy, where TD 220 and TD 222 are on one level of the hierarchy and TD 218 is on the next level. Although two levels in a tag directory (TD) hierarchy have been illustrated in FIG. 2A, other embodiments may include any number of levels in a TD hierarchy.

For example, if a request for a cache line misses the L1D cache 210, the request may check for the same cache line in the L2 cache 216. If the cache line is not in the L2 cache 216, then the request may continue to check the TD 220 to find out whether the cache line is located in one of the caches in the domain represented by the TD 220 (e.g., a cache controlled by the other cores in the same domain), for example, the caches of core C1 202B). Even if a copy of the cache line is found in a neighboring cache in the same domain, there may be other copies of the cache line in other domains (for example, domain of processor 204), which may be accounted for from a cache coherency perspective. Therefore, the request may need to continue to the TD 218, and check if any other domains also have a copy of the cache line. A tag directory or directories may be included as part of a cache line coherency hardware logic. Cache line coherency logic may include an on-die memory controller and/or off-die memory controller.

The hardware apparatuses and methods discussed herein may be implemented with any cache at any cache level and/or any processor or processor level (e.g., core).

FIG. 2B illustrates an embodiment of an in-flight chain 250 of cache line requests. Although each depicted hardware processor core (C0-C11) includes a missing address file (MAF), a MAF is optional. A MAF may refer to a request inflight table, e.g., as part of the cache line coherency logic. A MAF for each processor core may be included. The processor cores (which may include other processors and/or cores) may communicate with each other, e.g., via the cache line coherency logic. In one embodiment, the cache line coherency logic may include a MAF for each core to from the system interface perspective to allow for intra core communications and/or conflict resolution. In one embodiment, the MAF keeps track of state information required for coherence completion of transactions, snoops, and in-flight data from cache line requests.

In FIG. 2B, an in-flight chain 250 of cache line requests is formed. Particularly, FIG. 2B illustrates several requests to the same cache line having been made by multiple hardware processor cores, e.g., with core C1 being the oldest (e.g., first) requestor. For example, core C2 has sent a request to core C1 for a cache line (for example, a fill request for core C1 to fill core C2 with a cache line, e.g., the data therein), core C6 then sent a request (e.g., a fill request) for the cache line (e.g., the same data) to core C2, core C8 then sent a request (e.g., a fill request) to core C6 for the cache line (e.g., the same data), and core C9 then sent a request (e.g., a fill request) to core C9 for the cache line (e.g., the same data). FIG. 2B illustrates an eventual fill response 252BC to send the cache line from core C1 to core C2 (e.g., when core C1 has the cache line and is ready to forward the cache line to core C2), then an eventual fill response 252CG to send the cache line from core C2 to core C6 (e.g., when core C2 has the cache line and is ready to forward the cache line to core C6), then an eventual fill response 252GI to send the cache line from core C6 to core C8 (e.g., when core C6 has the cache line and is ready to forward the cache line to core C8), and then an eventual fill response 252IJ to send the cache line from core C8 to core C9 (e.g., when core C8 has the cache line and is ready to forward the cache line to core C9). In one embodiment, requestor core C2 has sent a request to a corresponding tag directory (not shown) for a cache line and the tag directory has indicated core C1 is the last accessor of the cache line so a forwarded request for the cache line (e.g., data) is sent to core C1. When the forwarded request arrives at core C1, it may determine (e.g., via cache line coherency logic) that core C1 has an outstanding request for the cache line (e.g., data), for example, a MAF entry is live for the cache line, and that request was ordered by the tag directory before the cache line request from core C2. Line 252BC may represents the (e.g., eventual or future) fill response that is to be sent from core C1 to core C2, e.g., when core C1 has the cache line (e.g., data) and is ready to forward it to core C2. The target core (e.g., requestor core C2) may be known (e.g., by the cache line coherency logic) because a field in the MAF of core C1 may indicate to send the cache line (e.g., data) to core C2 when ready. The cache line transmitted to a second processor from a first processor may be different than the cache line inputted into the first processor, e.g., from an arithmetic or a logic function. Cache line requests and/or (e.g., future) fill requests may be stored, e.g., in a MAF or other portion of cache line coherency logic. Cache line requests (e.g., probes) may be stored in a sending processor (e.g., core) and/or requesting processor (e.g., core), for example, in a MAF associated with each respective processor (e.g., core) or in a MAF of a sending or a receiving processor (e.g., core). In one embodiment, the in-flight chain 250 may continue to evaporate (e.g., be satisfied) as the fills are sent until eventually the last core to make a request to the line gets a fill (e.g., core C9 in FIG. 2B) and that in-flight chain may be gone. For example, at the end of the resolution of the in-flight chain 250 in FIG. 2B, copies of the cache line may be located at each core, e.g., the caches of cores C1, C2, C6, C8 and C9.

The arrows depicted in the Figures may refer to hardware logic or methods to move a cache line (e.g., data) or perform other operations, for example, hardware logic to perform those operations and/or instructions to cause those operations to be performed.

However, in certain embodiments, e.g., requests to the same cache line having been made by multiple hardware processor cores, an in-flight chain formed by a cache line coherency logic may block other (e.g., later) requests to access the same line. In one embodiment, a cache line coherency logic may block access to a cache line (e.g., data) when the cache line (e.g., data) is being moved from one location to another, for example, a cache line being moved from one cache (e.g., local to a first core or processor) to another cache (e.g., local to a first core or processor) or a cache line being moved from one cache to system memory. In certain embodiments, e.g., discussed below, cache line coherency hardware logic and methods do not block progress (e.g., access) of a request for a cache line that is being moved. In one embodiment, cache line coherency hardware logic and methods create a chain home (e.g., a (temporary) promise to fill a request) to deliver the cache line (e.g., data) to a conflicting requestor when the data arrives, for example, at the chain home or at the new location of the cache line. This may allow the conflicting request to the cache line to be processed (e.g., executed) and moved out of the way of subsequent requests instead of being blocked.

In some embodiments, a single tag can identify more than one processor core. Instead of using one bit to represent one processor core, and on bit can represent multiple processor cores. The tag directory, therefore, that uses one bit to represent multiple cores can be referred to as coarse directory.

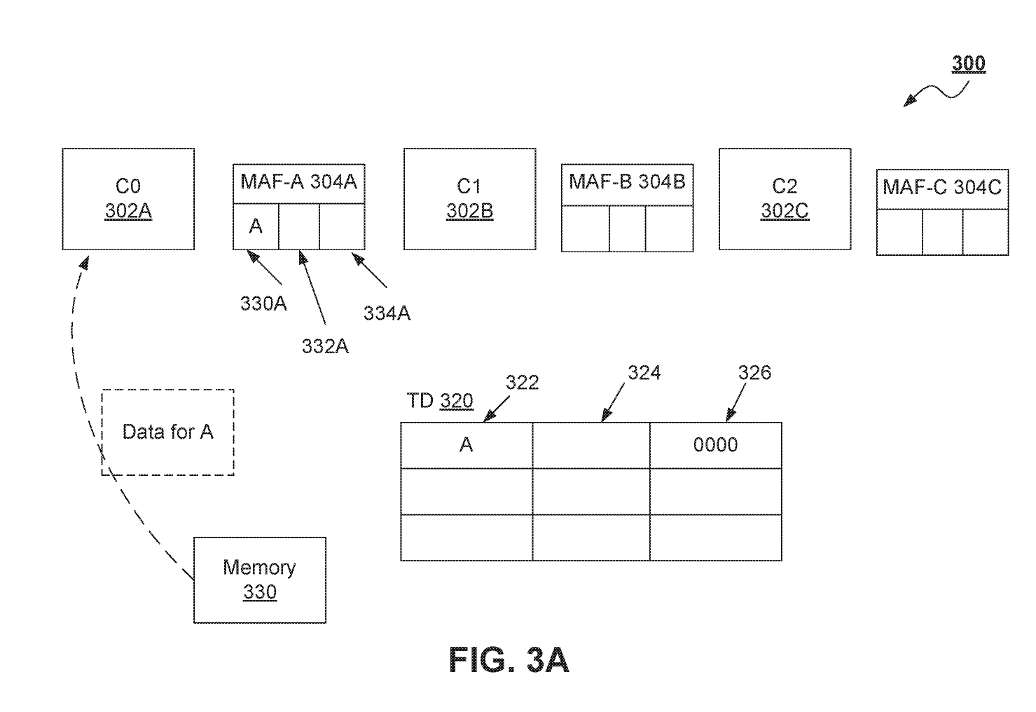

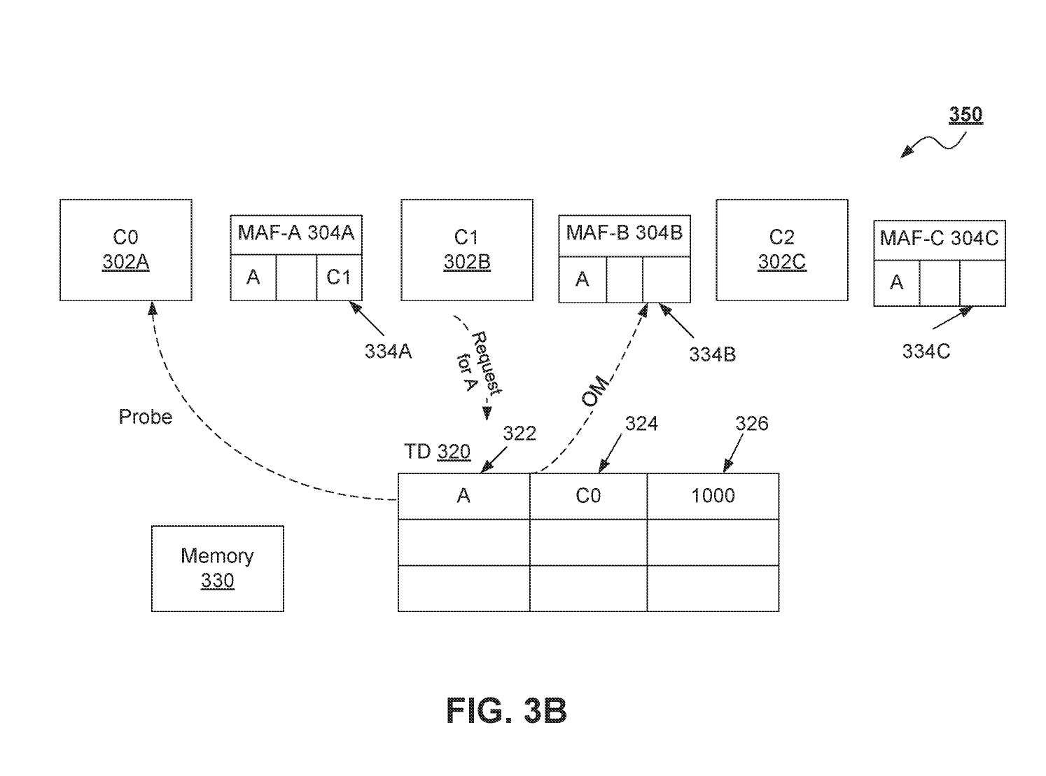

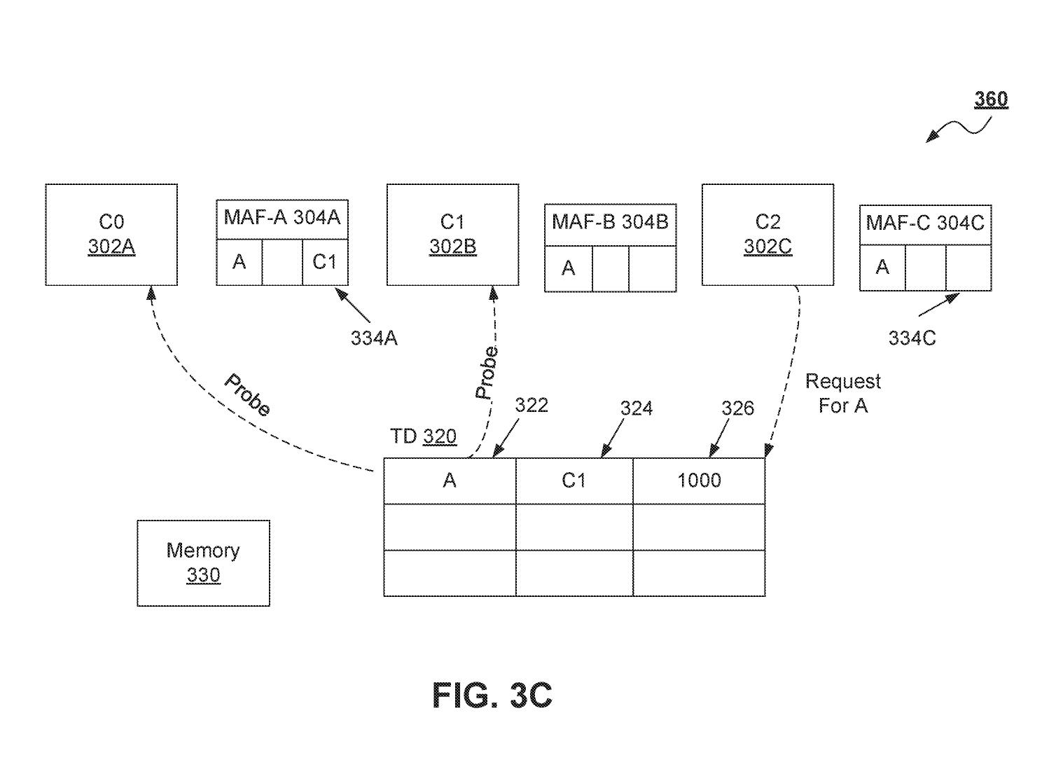

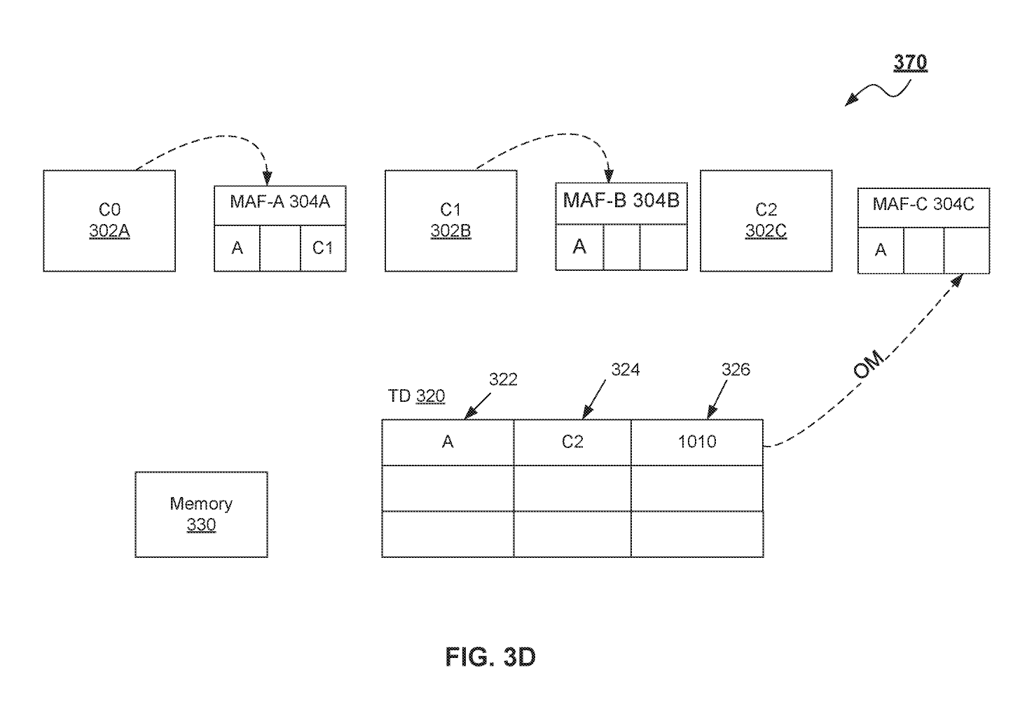

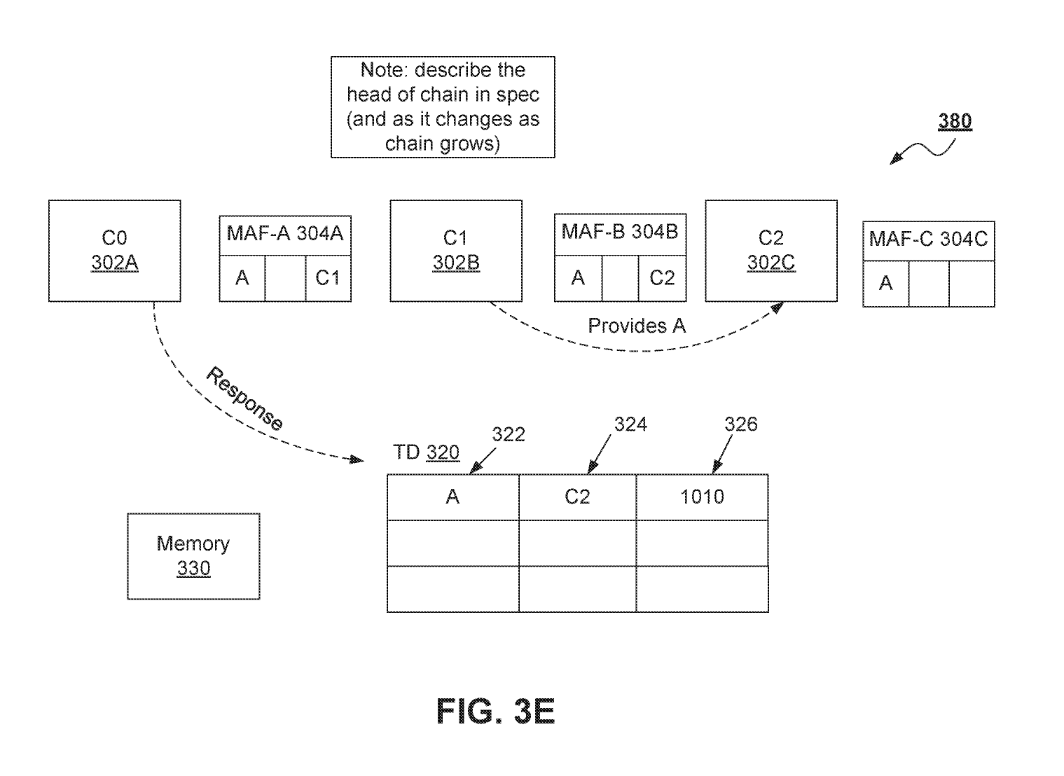

FIGS. 3A-3F are schematic diagrams of a process flow for a set of cores to establish a chain and maintain cache coherency using a coarse directory in accordance with embodiments of the present disclosure. FIGS. 3A-3F show three processor cores: C0 302A, C1 302B, and C2 302C. Each core can store information in a miss address file (MAF). For example, C0 302A stores information in MAF-A 304A, C1 302B stores information in MAF-B 304B, C2 302C stores information in MAF-C 304C. A tag directory (TG) 320 can assist with cache management by tracking memory addresses and current owners, as well as tracking active memory address requests. For example, tag directory can include a memory address field 322, a last processor core field 324, and a tag directory field 326.

FIG. 3A is a schematic diagram 300 of a process flow for a set of cores to establish a chain and maintain cache coherency using a coarse directory in accordance with embodiments of the present disclosure. In FIG. 3A, core C0 302A has made a request for access to memory location A from memory 330. In some embodiments, the request for access to memory location can be made through the TD 320, and in the case of a cache miss, the core C0 302A can access a memory 330 for the data. Upon receiving the data for memory address A, the core C0 can store the indication of memory address A in its MAF-A 304A.

Each MAF includes an address field 330A, an instruction field 332A, and a chain field 334A. The address field 330A can store data and the indication of the address location the data is stored in. The instruction field 332A can store instructions that the core must execute after servicing and/or transmitting data for a corresponding address location. The chain field 334A can store a next-in-line core that will service the data. A null in the chain field can indicate that the core is the head of chain.

FIG. 3B is a schematic diagram 350 of a process flow for a set of cores to establish a chain and maintain cache coherency using a coarse directory in accordance with embodiments of the present disclosure. In FIG. 3B, the tag directory 320 has been updated in the directory field 326 that C0 302A has made a request for memory address A. The tag directory indicates that C0 302A has made such a request by updating the directory field bit to 1000, and updating the last processor core field 324 to C0. The bits used herein are for example purposes, and in some implementations, other bits can be used to represent processor cores in the tag directory.

In FIG. 3B, core C1 302B makes a request for access to memory address A. The tag directory (or other object request broker) can identify any known previous accessors of memory address A using the tag directory field 326 (e.g., bit 1000 indicating C0 and other cores associated with bit 1000; the TD 320 will also use the last processor core field 324 to specifically identify core C0). The tag directory can send a request (such as a probe or a snoop) to C0 and to any other cores that are represented in the coarse directory by the 1000 bit. The request message can include an indication of the requesting core, in this case C1 304A. C0 302A can include an indication of C1 302B in the MAF-A 304A. C1 302B can update its MAF-B 304B with the memory address A. C1 302B can also receive an order marker from TD 320, which can cause C1 302B to clear the chain field 334B.

FIG. 3C is a schematic diagram 360 of a process flow for a set of cores to establish a chain and maintain cache coherency using a coarse directory in accordance with embodiments of the present disclosure. In FIG. 3C, the tag directory 320 includes an entry reflecting that core C1 has made a memory access request for memory address A. The field 324 reflects C1 as the last processor core to make an access request and field 326 still reflects bits 1000. Bits 1000 are coarse bits that indicate that C0 and C1 both are represented by the single bit 1000.

The core C2 302C can also make a request for access to the memory address A, subsequently to the request made by C1 302B. The TD 320 can send a probe to C0 302A and C1 302B based on the coarse directory bit 326 set to 1000; the TD 320 will also send a probe to any other core that is associated with the bits 1000 (e.g., C0 302A and C1 302B). The probes sent to C0 302A and C1 302B include a reference to C2 302C. Probes are sent to both C0 302A and C1 302B because both are represented by the coarse bit 1000 in the TD 320.

FIG. 3D is a schematic diagram 370 of a process flow for a set of cores to establish a chain and maintain cache coherency using a coarse directory in accordance with embodiments of the present disclosure. C1 302B having received a probe referencing C2 302C can consult its MAF-A 304A to determine how to respond to the probe. More specifically, C0 302A can determine whether the processor core referenced in the MAF-A 304A is the same as the core referenced in the probe. Similarly, C1 302B can consult MAF-B 304B.

The tag directory also reflects the access request from C2 302C and updates the tag field to bits 1010.

The tag directory can also send an order marker to C2 302C to indicate to C2 302C that C2 302C will be the head of chain.

FIG. 3E is a schematic diagram 380 of a process flow for a set of cores to establish a chain and maintain cache coherency using a coarse directory in accordance with embodiments of the present disclosure. C1 302A having received a probe referencing C2 can consult its MAF-A 304A to determine how to respond to the probe. Because the MAF-A 304A indicates C1 as a next processor core in line for servicing A, which is different from the core referenced in the probe (i.e., C2), core C0 can send a response message to the TD 320. The response message can include a response invalid message or a response shared message. In either case, the core C0 302A does not buffer the probe; instead, the core C0 302A can respond immediately to the probe after making the determination that the probe references a different core than that stored in MAF-A 304A (and associated with memory address A).

The core C1 302B can determine that there are no next-in-line processor cores to service memory address A. C1 302B can send the data from address A to C2 302C.

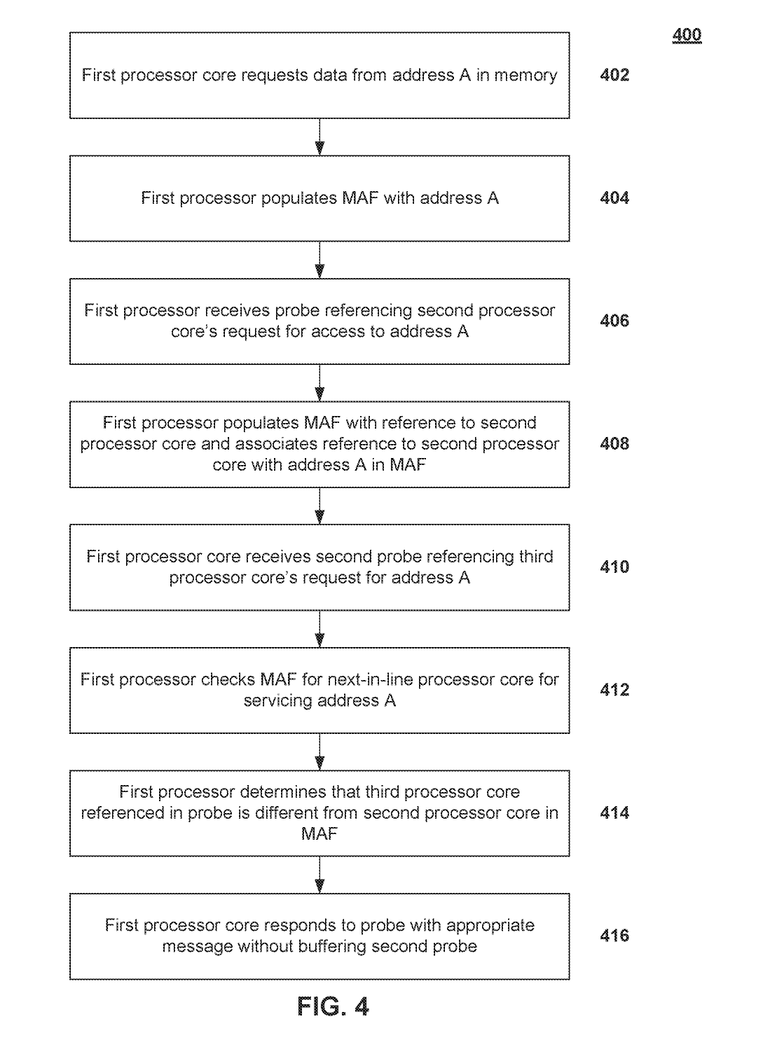

FIG. 4 is a process flow diagram for a processor core to respond to a request for access to a memory location without buffering the request in accordance with embodiments of the present disclosure. A first processor can request data from address A in memory (402). The first processor can access memory after a cache miss. The first processor can receive the data and populate the MAF data structure with an indication of address A from memory (404).

The first processor can receive a first request for memory access (e.g., a probe or snoop) referencing a second processor core and the second processor core's request for access to address A (406). The first processor can determine that the MAF entry for address A does not include a next-in-line processor core that wants to service memory address A; the first processor can then populate the MAF entry for address A with the reference to the second processor core (408).

The first processor core can receive a second request for memory access to address A (e.g., a probe or snoop), the second request referencing a third processor core making the request (410). The first processor can consult the MAF to determine whether the second processor core referenced in the MAF and associated with memory address A is the same as the third processor core from the second request (412). If the second processor core stored in the MAF and associated with address A is different from the third processor core referenced in the second request (414), then the first processor core can respond to the tag directory, object request broker, or other cache management entity, with an appropriate response (416). For example, the response message can include a response invalid message (RspI) or a response shared message (RspS).

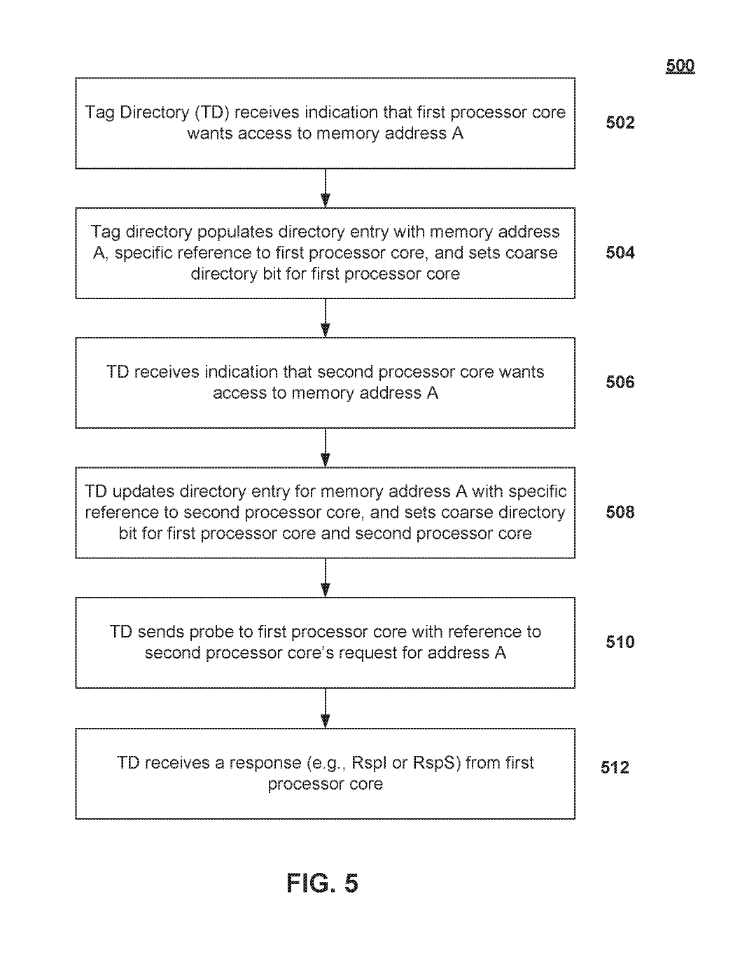

FIG. 5 is a process flow diagram for an object request broker to manage cache states in accordance with embodiments of the present disclosure. The tag directory can receive an indication that a first processor core wants access to a memory address location A (502). The tag directory can update the tag directory with an entry of the memory address A and a reference to the first processor core, and sets a coarse directory bit to correspond with the first processor core (504).

The tag directory receives an indication that the second processor core wants access to memory address A (506). The tag directory updates the tag directory entry for memory address A with a specific reference to the second processor core and sets the coarse directory bit for the second processor (e.g., without resetting the coarse directory bit for the first processor core) (508).

The tag directory can send a probe to the first processor core with a reference to the second processor core's request for address A (510). The tag directory sends a probe to each processor core that also corresponds with the coarse directory bit for the first processor core.

The tag directory receives a response message from the first processor core, such as a response invalid or response shared message (512).

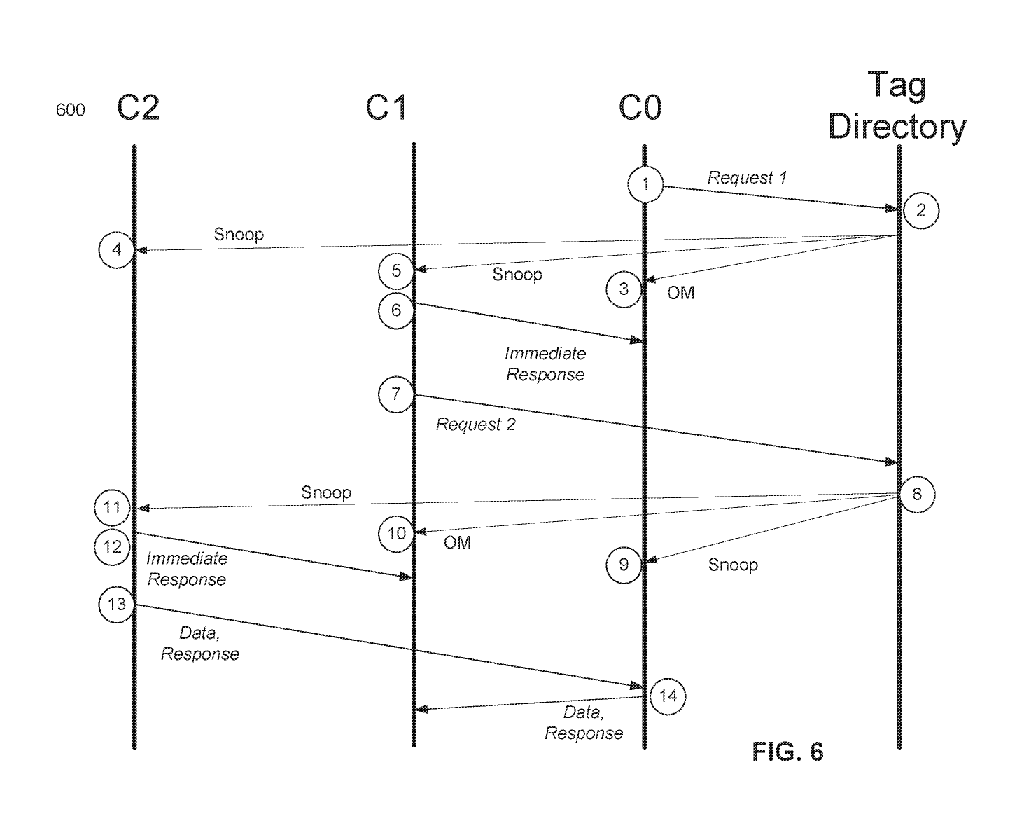

FIG. 6 is a diagram illustrating message flows 600 between three processor cores and a home agent in accordance with embodiments of the present disclosure. FIG. 6 illustrates how caching agents can provide immediate responses to snoops (aka, probes) and how the caching agents can use the miss address file (MAF) to determining how to respond to snoops that are sent by a tag directory using a coarse tag directory field.

FIG. 6 shows three caching agents: C2, C1, and C0. Caching agents can be considered processor cores, such as those described herein. In this example, caching agent C2 can be considered to be the head of a chain. Also in this example, though caching agent C2 is head of the chain, caching agent C2 does not yet have the data that is being sought after at the memory address location (address A for simplicity). Because caching agent C2 is the head of the chain, at the outset there is no caching agent in its MAF chain field (e.g., the field in the MAF that contains a reference to a caching agent that wants to service the data at the corresponding address location).

In FIG. 6, certain event points are identified by circled numbers. Though numbered sequentially, it is understood that certain events may occur at substantially the same time or, in some cases, the sequence of events shown in FIG. 6 may be performed in a different order. The numbering is to tie events to the corresponding written description.

At point 1 in the message flow, caching agent C0 sends a request (Request1) to the tag directory for the data at address A. The tag directory includes a coarse tag field, where each bit of the coarse tag identifies a plurality of caching agents that have made a previous request for the data at a corresponding address location (here, address location A). The tag directory sends a snoop to each caching agent represented by the coarse directory tag at point 2. In this example, each of caching agents C2, C1, and C0 are represented by the same bit. Therefore, the tag directory sends a snoop to both caching agents C2 and C1 (though not C0 because C0 is the caching agent making this request). The tag directory can also update its ownership field to reflect that caching agent C0 is now the owner of the data at memory location A.

At point 3, the tag directory can send an order marker to caching agent C0. The caching agent C0 can use the order marker as a handshake for C0 to now consider itself as the head of the chain. The head of chain can be reflected by a null entry in the chain field of caching agent C0's MAF.

At point 4, caching agent C2 receives the snoop. Caching agent C2 at point 4 is the head of the chain but has not yet received the data at memory location A. Therefore, caching agent C2 cannot respond to the snoop. Instead, caching agent C2 can store the snoop and snoop type in MAF. For example, caching agent C2 can store a reference to C0 in the MAF chain field. Now that caching agent C2 has the reference to caching agent C0 in the MAF chain field, caching agent C2 will no longer consider itself as the head of the chain.

Also, for example, if the snoop type is invalidating (e.g., caching agent C0's request is a write request), then the caching agent C2 can store an invalidation instruction in MAF. When caching agent C2 receives the data at memory location A, caching agent C2 can process the data, send the data to caching agent C0 to satisfy C0's request for the data, and invalidate the data is has stored in its cache and its MAF associated with memory location A.

At point 5, caching agent C1 receives the snoop from the tag directory. Caching agent C1 can consult its MAF to determine that it is not the head of the chain and therefore cannot provide the data at address A to caching agent C0. Therefore, at point 6, caching agent C1 can immediately respond to the snoop by sending a response message to caching agent C0. Agent C1 does not buffer the snoop, but instead sends an immediate response to caching agent C0.

In FIG. 6, while caching agent C2 is awaiting the data for memory address A, caching agent C1 makes a request to the tag directory for the data at memory address A (at point 7). The caching agent C1 makes the request to the tag directory. At point 8, the tag directory can send a snoop to caching agents C2 and C0. The tag directory also updates its ownership field to reflect that C1 is the new owner of the data at memory location A. The tag directory also sends an order marker to C1, which is a handshake to C1 that indicates that C1 is the new head of chain (i.e., the chain field in MAF will be empty at point 10).

At point 11, caching agent C2 receives the snoop from the tag directory concerning caching agent C1's request for the data at address location A. Caching agent C2 at point 12 can look at the chain field in MAF, which is populated with a reference to caching agent C0 (from point 4). That C0 is in caching agent's C2 chain MAF field indicates to caching agent C2 that it is no longer head of chain. Caching agent C2 can therefore respond immediately to C1's request (Request2, at point 12).

At point 9, caching agent C0 also receives a snoop (because the tag directory's coarse tag indicates that caching agents C2 and C0 are servicing data from A). Caching agent C0 can consult the MAF and see that caching agent C0 is the head of the chain because the MAF chain field is empty. At point 9, caching agent C0 has yet to receive the data from caching agent C2. Therefore, caching agent C0 can store the snoop as a reference to C1 in the chain field of caching agent C0's MAF.

At point 13, caching agent C2 receives the data for address A and services the data. Caching agent C2 then send the data and a corresponding response message to caching agent C0 to satisfy caching agent C0's request. To continue the example from above, caching agent C2 then invalidates the data it has stored in its cache that is associated with address A (in some emboidments, the data is also invalidated for address A in the MAF, too).

At point 14, caching agent C0 receives the data and services the data. When caching agent C0 is complete, caching agent C0 can consult its MAF and identify C1 as a next-in-line caching agent for servicing the data. Caching agent C0 then sends the data and a response message to C1. Caching agent C0 can then perform other operations, such as invalidation or other operations, based on the snoop caching agent C0 received based on the request from caching agent C1.

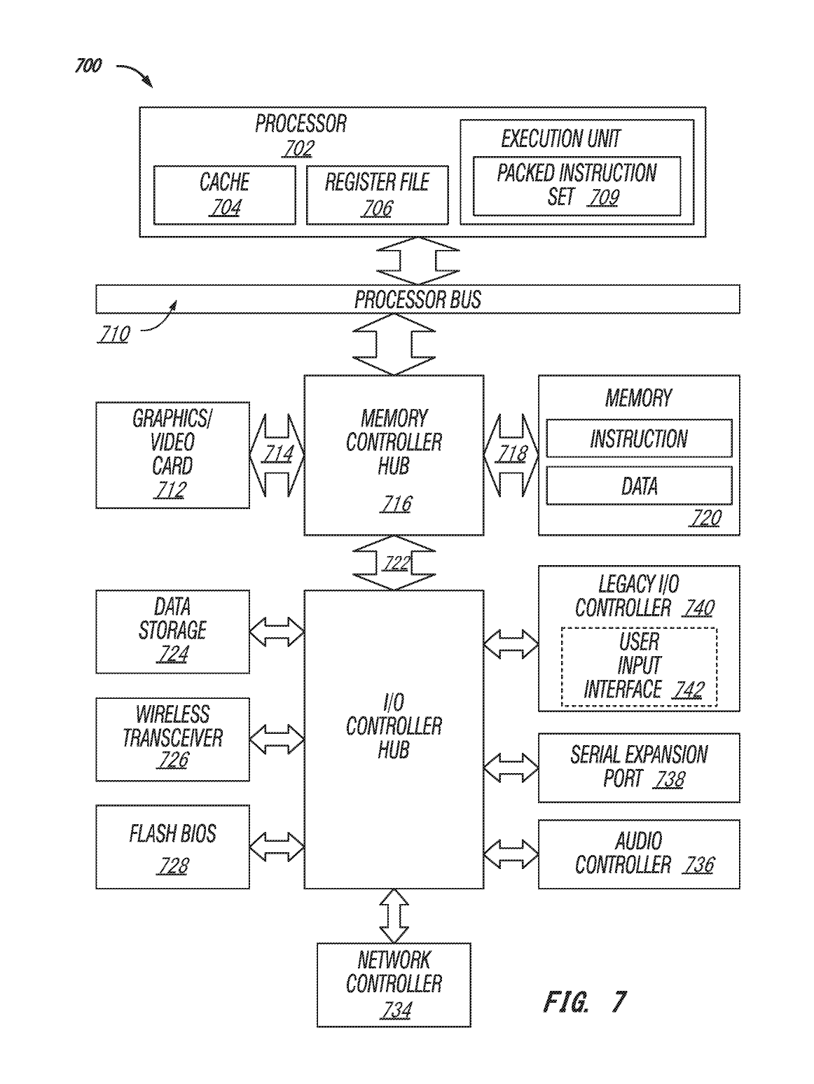

Turning to FIG. 7, a block diagram of an exemplary computer system formed with a processor that includes execution units to execute an instruction, where one or more of the interconnects implement one or more features in accordance with one embodiment of the present invention is illustrated. System 700 includes a component, such as a processor 702 to employ execution units including logic to perform algorithms for process data, in accordance with the present invention, such as in the embodiment described herein. System 700 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 700 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 702 includes one or more execution units 708 to implement an algorithm that is to perform at least one instruction. One embodiment may be described in the context of a single processor desktop or server system, but alternative embodiments may be included in a multiprocessor system. System 700 is an example of a ‘hub’ system architecture. The computer system 700 includes a processor 702 to process data signals. The processor 702, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 702 is coupled to a processor bus 710 that transmits data signals between the processor 702 and other components in the system 700. The elements of system 700 (e.g. graphics accelerator 712, memory controller hub 716, memory 720, I/O controller hub 724, wireless transceiver 726, Flash BIOS 728, Network controller 734, Audio controller 736, Serial expansion port 738, I/O controller 740, etc.) perform their conventional functions that are well known to those familiar with the art.

In one embodiment, the processor 702 includes a Level 1 (L1) internal cache memory 704. Depending on the architecture, the processor 702 may have a single internal cache or multiple levels of internal caches. Other embodiments include a combination of both internal and external caches depending on the particular implementation and needs. Register file 706 is to store different types of data in various registers including integer registers, floating point registers, vector registers, banked registers, shadow registers, checkpoint registers, status registers, and instruction pointer register.

Execution unit 708, including logic to perform integer and floating point operations, also resides in the processor 702. The processor 702, in one embodiment, includes a microcode (ucode) ROM to store microcode, which when executed, is to perform algorithms for certain macroinstructions or handle complex scenarios. Here, microcode is potentially updateable to handle logic bugs/fixes for processor 702. For one embodiment, execution unit 708 includes logic to handle a packed instruction set 709. By including the packed instruction set 709 in the instruction set of a general-purpose processor 702, along with associated circuitry to execute the instructions, the operations used by many multimedia applications may be performed using packed data in a general-purpose processor 702. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 708 may also be used in micro controllers, embedded processors, graphics devices, DSPs, and other types of logic circuits. System 700 includes a memory 720. Memory 720 includes a dynamic random access memory (DRAM) device, a static random access memory (SRAM) device, flash memory device, or other memory device. Memory 720 stores instructions and/or data represented by data signals that are to be executed by the processor 702.

Note that any of the aforementioned features or aspects of the invention may be utilized on one or more interconnect illustrated in FIG. 7. For example, an on-die interconnect (ODI), which is not shown, for coupling internal units of processor 702 implements one or more aspects of the invention described above. Or the invention is associated with a processor bus 710 (e.g. Intel Quick Path Interconnect (QPI) or other known high performance computing interconnect), a high bandwidth memory path 718 to memory 720, a point-to-point link to graphics accelerator 712 (e.g. a Peripheral Component Interconnect express (PCIe) compliant fabric), a controller hub interconnect 722, an I/O or other interconnect (e.g. USB, PCI, PCIe) for coupling the other illustrated components. Some examples of such components include the audio controller 736, firmware hub (flash BIOS) 728, wireless transceiver 726, data storage 724, legacy I/O controller 710 containing user input and keyboard interfaces 742, a serial expansion port 738 such as Universal Serial Bus (USB), and a network controller 734. The data storage device 724 can comprise a hard disk drive, a floppy disk drive, a CD-ROM device, a flash memory device, or other mass storage device.

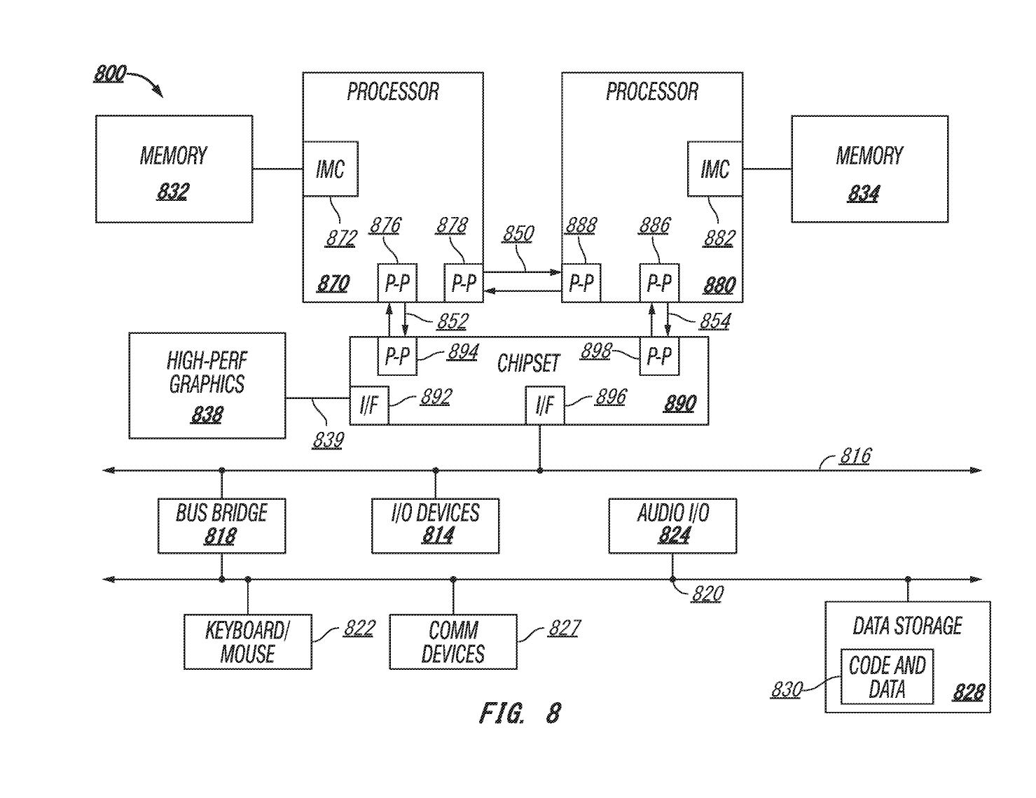

Referring now to FIG. 8, shown is a block diagram of a second system 800 in accordance with an embodiment of the present invention. As shown in FIG. 8, multiprocessor system 800 is a point-to-point interconnect system, and includes a first processor 870 and a second processor 880 coupled via a point-to-point interconnect 850. Each of processors 870 and 880 may be some version of a processor. In one embodiment, 852 and 854 are part of a serial, point-to-point coherent interconnect fabric, such as Intel's Quick Path Interconnect (QPI) architecture. As a result, the invention may be implemented within the QPI architecture.

While shown with only two processors 870, 880, it is to be understood that the scope of the present invention is not so limited. In other embodiments, one or more additional processors may be present in a given processor.

Processors 870 and 880 are shown including integrated memory controller units 872 and 882, respectively. Processor 870 also includes as part of its bus controller units point-to-point (P-P) interfaces 876 and 878; similarly, second processor 880 includes P-P interfaces 886 and 888. Processors 870, 880 may exchange information via a point-to-point (P-P) interface 850 using P-P interface circuits 878, 888. As shown in FIG. 8, IMCs 872 and 882 couple the processors to respective memories, namely a memory 832 and a memory 834, which may be portions of main memory locally attached to the respective processors.

Processors 870, 880 each exchange information with a chipset 890 via individual P-P interfaces 852, 854 using point to point interface circuits 876, 894, 886, 898. Chipset 890 also exchanges information with a high-performance graphics circuit 838 via an interface circuit 892 along a high-performance graphics interconnect 839.

A shared cache (not shown) may be included in either processor or outside of both processors; yet connected with the processors via P-P interconnect, such that either or both processors' local cache information may be stored in the shared cache if a processor is placed into a low power mode.

Chipset 890 may be coupled to a first bus 816 via an interface 896. In one embodiment, first bus 816 may be a Peripheral Component Interconnect (PCI) bus, or a bus such as a PCI Express bus or another third generation I/O interconnect bus, although the scope of the present invention is not so limited.

As shown in FIG. 8, various I/O devices 814 are coupled to first bus 816, along with a bus bridge 818 which couples first bus 816 to a second bus 820. In one embodiment, second bus 820 includes a low pin count (LPC) bus. Various devices are coupled to second bus 820 including, for example, a keyboard and/or mouse 822, communication devices 827 and a storage unit 828 such as a disk drive or other mass storage device which often includes instructions/code and data 830, in one embodiment. Further, an audio I/O 824 is shown coupled to second bus 820. Note that other architectures are possible, where the included components and interconnect architectures vary. For example, instead of the point-to-point architecture of FIG. 8, a system may implement a multi-drop bus or other such architecture.

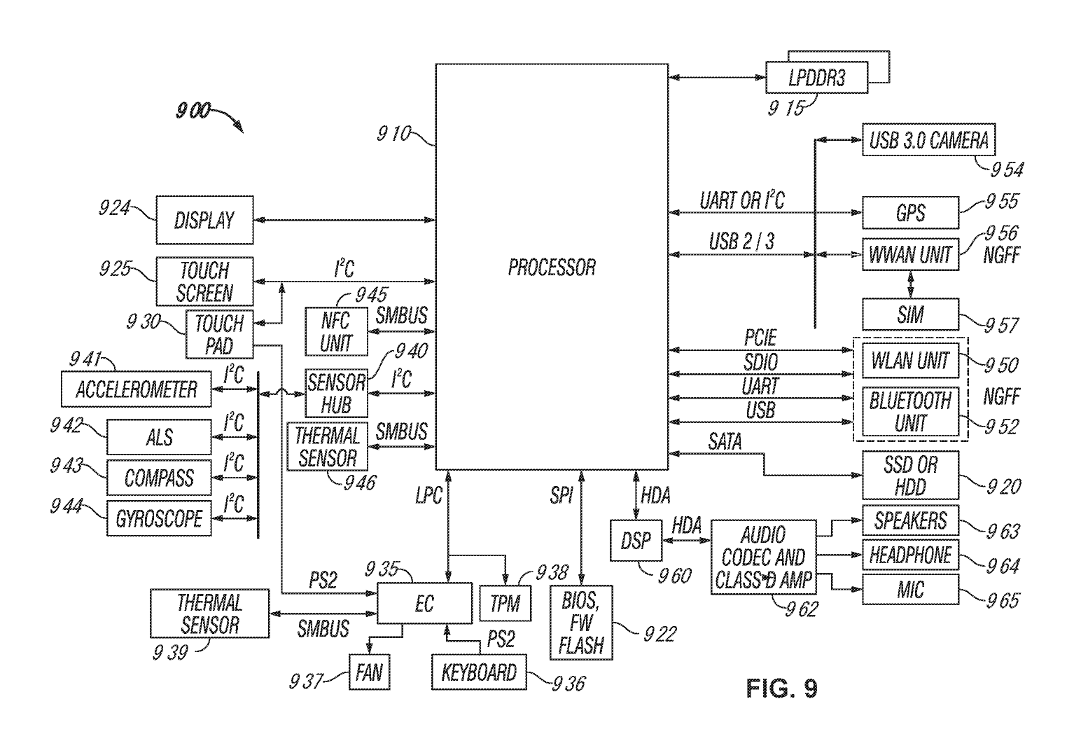

FIG. 9

Referring now to FIG. 9, a block diagram of components present in a computer system in accordance with an embodiment of the present invention is illustrated. As shown in FIG. 9, system 900 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 9 is intended to show a high level view of many components of the computer system. However, it is to be understood that some of the components shown may be omitted, additional components may be present, and different arrangement of the components shown may occur in other implementations. As a result, the invention described above may be implemented in any portion of one or more of the interconnects illustrated or described below.

As seen in FIG. 9, a processor 910, in one embodiment, includes a microprocessor, multi-core processor, multithreaded processor, an ultra low voltage processor, an embedded processor, or other known processing element. In the illustrated implementation, processor 910 acts as a main processing unit and central hub for communication with many of the various components of the system 900. As one example, processor 900 is implemented as a system on a chip (SoC). As a specific illustrative example, processor 910 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitectural implementation may vary, but the architectural function of the processor is usually consistent. Certain details regarding the architecture and operation of processor 910 in one implementation will be discussed further below to provide an illustrative example.

Processor 910, in one embodiment, communicates with a system memory 915. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (Q17P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDlMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 920 may also couple to processor 910. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 9, a flash device 922 may be coupled to processor 910, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (IO) devices may be present within system 900. Specifically shown in the embodiment of FIG. 9 is a display 924 which may be a high definition LCD or LED panel configured within a lid portion of the chassis. This display panel may also provide for a touch screen 925, e.g., adapted externally over the display panel such that via a user's interaction with this touch screen, user inputs can be provided to the system to enable desired operations, e.g., with regard to the display of information, accessing of information and so forth. In one embodiment, display 924 may be coupled to processor 910 via a display interconnect that can be implemented as a high performance graphics interconnect. Touch screen 925 may be coupled to processor 910 via another interconnect, which in an embodiment can be an I²C interconnect. As further shown in FIG. 9, in addition to touch screen 925, user input by way of touch can also occur via a touch pad 930 which may be configured within the chassis and may also be coupled to the same I²C interconnect as touch screen 925.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080p), be compatible with an embedded display port (eDP), and be a low power panel with panel self refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass' or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited IO interference when using multi-touch.

For perceptual computing and other purposes, various sensors may be present within the system and may be coupled to processor 910 in different manners. Certain inertial and environmental sensors may couple to processor 910 through a sensor hub 940, e.g., via an I²C interconnect. In the embodiment shown in FIG. 9, these sensors may include an accelerometer 941, an ambient light sensor (ALS) 942, a compass 943 and a gyroscope 944. Other environmental sensors may include one or more thermal sensors 946 which in some embodiments couple to processor 910 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

In an embodiment, the OS may be a Microsoft® Windows® 8 OS that implements Connected Standby (also referred to herein as Win8 CS). Windows 8 Connected Standby or another OS having a similar state can provide, via a platform as described herein, very low ultra idle power to enable applications to remain connected, e.g., to a cloud-based location, at very low power consumption. The platform can supports 3 power states, namely screen on (normal); Connected Standby (as a default “off” state); and shutdown (zero watts of power consumption). Thus in the Connected Standby state, the platform is logically on (at minimal power levels) even though the screen is off. In such a platform, power management can be made to be transparent to applications and maintain constant connectivity, in part due to offload technology to enable the lowest powered component to perform an operation.

Also seen in FIG. 9, various peripheral devices may couple to processor 910 via a low pin count (LPC) interconnect. In the embodiment shown, various components can be coupled through an embedded controller 935. Such components can include a keyboard 936 (e.g., coupled via a PS2 interface), a fan 937, and a thermal sensor 939. In some embodiments, touch pad 930 may also couple to EC 935 via a PS2 interface. In addition, a security processor such as a trusted platform module (TPM) 938 in accordance with the Trusted Computing Group (TCG) TPM Specification Version 1.2, dated Oct. 2, 2003, may also couple to processor 910 via this LPC interconnect. However, understand the scope of the present invention is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus Revision 3.0 Specification (November 2008), with at least one powered for charging of USB devices (such as smartphones) when the system is in Connected Standby state and is plugged into AC wall power. In addition, one or more Thunderbolt™ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 900 can communicate with external devices in a variety of manners, including wirelessly. In the embodiment shown in FIG. 9, various wireless modules, each of which can correspond to a radio configured for a particular wireless communication protocol, are present. One manner for wireless communication in a short range such as a near field may be via a near field communication (NFC) unit 945 which may communicate, in one embodiment with processor 910 via an SMBus. Note that via this NFC unit 945, devices in close proximity to each other can communicate. For example, a user can enable system 900 to communicate with another (e.g.,) portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 9, additional wireless units can include other short range wireless engines including a WLAN unit 950 and a Bluetooth unit 952. Using WLAN unit 950, Wi-Fi™ communications in accordance with a given Institute of Electrical and Electronics Engineers (IEEE) 802.11 standard can be realized, while via Bluetooth unit 952, short range communications via a Bluetooth protocol can occur. These units may communicate with processor 910 via, e.g., a USB link or a universal asynchronous receiver transmitter (UART) link. Or these units may couple to processor 910 via an interconnect according to a Peripheral Component Interconnect Express™ (PCIe™) protocol, e.g., in accordance with the PCI Express' Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 956 which in turn may couple to a subscriber identity module (SIM) 957. In addition, to enable receipt and use of location information, a GPS module 955 may also be present. Note that in the embodiment shown in FIG. 9, WWAN unit 956 and an integrated capture device such as a camera module 954 may communicate via a given USB protocol such as a USB 2.0 or 3.0 link, or a UART or I²C protocol. Again the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 960, which may couple to processor 910 via a high definition audio (HDA) link. Similarly, DSP 960 may communicate with an integrated coder/decoder (CODEC) and amplifier 962 that in turn may couple to output speakers 963 which may be implemented within the chassis. Similarly, amplifier and CODEC 962 can be coupled to receive audio inputs from a microphone 965 which in an embodiment can be implemented via dual array microphones (such as a digital microphone array) to provide for high quality audio inputs to enable voice-activated control of various operations within the system. Note also that audio outputs can be provided from amplifier/CODEC 962 to a headphone jack 964. Although shown with these particular components in the embodiment of FIG. 9, understand the scope of the present invention is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 910 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the I/O pins for several I/O signals, such as the interface between the processor and a PCH, the interface with the external VR and the interface with EC 935. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC 935 may be sent to the PCH instead of the processor during the connected standby state so that the PCH can manage the wakeup processing instead of the processor. In addition, the TSC is maintained in the PCH to facilitate sustaining processor architectural functions. Although shown with these particular components in the embodiment of FIG. 9, understand the scope of the present invention is not limited in this regard.

Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

Some implementations may provide a specific power management IC (PMIC) to control platform power. Using this solution, a system may see very low (e.g., less than 5%) battery degradation over an extended duration (e.g., 16 hours) when in a given standby state, such as when in a Win8 Connected Standby state. In a Win8 idle state a battery life exceeding, e.g., 9 hours may be realized (e.g., at 150 nits). As to video playback, a long battery life can be realized, e.g., full HD video playback can occur for a minimum of 6 hours. A platform in one implementation may have an energy capacity of, e.g., 35 watt hours (Whr) for a Win8 CS using an SSD and (e.g.,) 40-44Whr for Win8 CS using an HDD with a RST cache configuration.

A particular implementation may provide support for 15 W nominal CPU thermal design power (TDP), with a configurable CPU TDP of up to approximately 25 W TDP design point. The platform may include minimal vents owing to the thermal features described above. In addition, the platform is pillow-friendly (in that no hot air is blowing at the user). Different maximum temperature points can be realized depending on the chassis material. In one implementation of a plastic chassis (at least having to lid or base portion of plastic), the maximum operating temperature can be 52 degrees Celsius (C). And for an implementation of a metal chassis, the maximum operating temperature can be 46° C.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

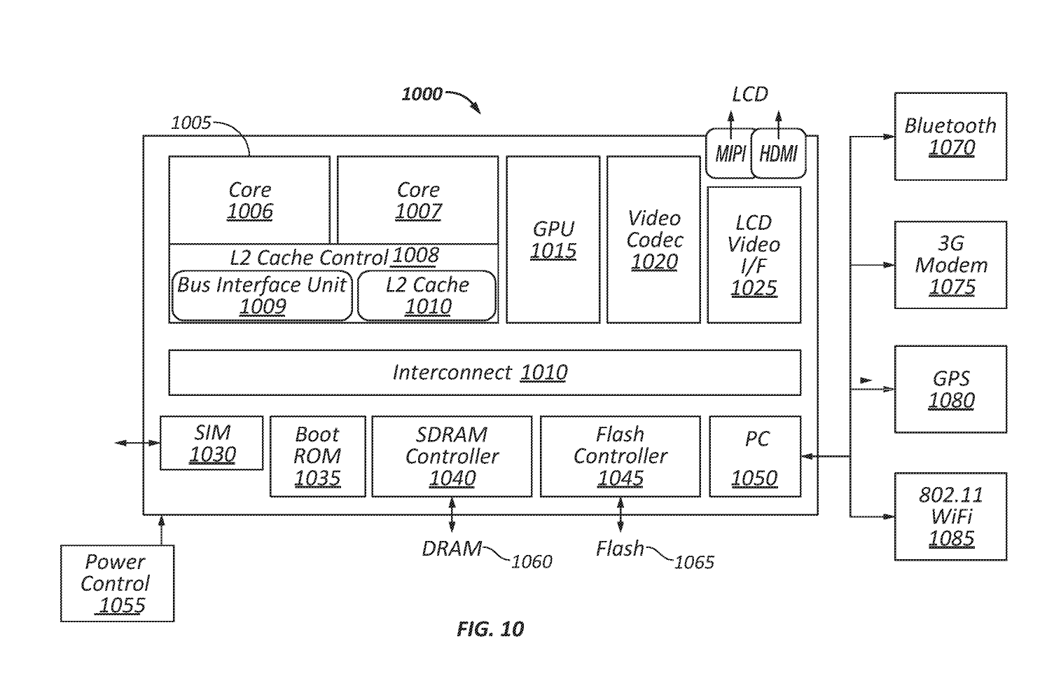

Turning next to FIG. 10, an embodiment of a system on-chip (SOC) design in accordance with the inventions is depicted. As a specific illustrative example, SOC 1000 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1000 includes 2 cores—1006 and 1007. Similar to the discussion above, cores 1006 and 1007 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1006 and 1007 are coupled to cache control 1008 that is associated with bus interface unit 1009 and L2 cache 1010 to communicate with other parts of system 1000. Interconnect 1010 includes an on-chip interconnect, such as an IOSF, AMBA, or other interconnect discussed above, which potentially implements one or more aspects of the described invention.

Interface 1010 provides communication channels to the other components, such as a Subscriber Identity Module (SIM) 1030 to interface with a SIM card, a boot ROM 1035 to hold boot code for execution by cores 1006 and 1007 to initialize and boot SOC 1000, a SDRAM controller 1040 to interface with external memory (e.g. DRAM 1060), a flash controller 1045 to interface with non-volatile memory (e.g. Flash 1065), a peripheral control Q1650 (e.g. Serial Peripheral Interface) to interface with peripherals, video codecs 1020 and Video interface 1025 to display and receive input (e.g. touch enabled input), GPU 1015 to perform graphics related computations, etc. Any of these interfaces may incorporate aspects of the invention described herein.

In addition, the system illustrates peripherals for communication, such as a Bluetooth module 1070, 3G modem 1075, GPS 1085, and WiFi 1085. Note as stated above, a UE includes a radio for communication. As a result, these peripheral communication modules are not all required. However, in a UE some form a radio for external communication is to be included.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Aspects of the embodiments can include one or a combination of the following examples:

Example 1 is a first processor core apparatus including logic circuitry to request access to a memory address; logic circuitry to store an identification of the memory address in a data structure; logic circuitry to receive a first request for access to the memory address, the request comprising a reference to a second processor core; logic circuitry to store the reference to the second processor in the data structure; logic circuitry to receive a second request for access to the memory address, the second request comprising a reference to a third processor core; logic circuitry to determine, based on the data structure, that the third processor core is different from the second processor core; and logic circuitry to respond to the second request without buffering the second request.

Example 2 may include the subject matter of example 1, wherein the logic circuitry to respond to the second request comprises logic circuitry to respond with one of a response invalid message (rspI) or response shared message (rspS).

Example 3 may include the subject matter of any of examples 1 or 2, wherein the logic circuitry to respond to the second request comprises logic circuitry to transmit a response message to the third processor core.

Example 4 may include the subject matter of any of examples 1-3, wherein the data structure comprises a miss address file (MAF).

Example 5 may include the subject matter of any of examples 1-4, wherein the logic circuitry to determine that the third processor core is different from the second processor core comprises logic circuitry to compare the reference to the second processor core in the data structure to the reference to the third processor core in the second request for access to the memory address.

Example 6 may include the subject matter of any of examples 1-5, wherein the first request comprises a first probe from a tag directory and the second request comprises a second probe from the tag directory.

Example 7 is a computer implemented method that includes requesting access to a memory address; storing an identification of the memory address in a data structure; receiving a first request for access to the memory address, the request comprising a reference to a second processor core; storing the reference to the second processor in the data structure; receiving a second request for access to the memory address, the second request comprising a reference to a third processor core; determining, based on the data structure, that the third processor core is different from the second processor core; and responding to the second request without buffering the second request.

Example 8 may include the subject matter of example 7, wherein responding to the second request comprises responding with one of a response invalid message (rspI) or response shared message (rspS).

Example 9 may include the subject matter of any of examples 7-8, wherein responding to the second request comprises transmitting a response message to a cache controller.

Example 10 may include the subject matter of any of examples 7-9, wherein the data structure comprises a miss address file (MAF).

Example 11 may include the subject matter of any of examples 7-10, wherein determining that the third processor core is different from the second processor core comprises comparing the reference to the second processor core in the data structure to the reference to the third processor core in the second request for access to the memory address.

Example 12 may include the subject matter of any of examples 7-11, wherein the first request comprises a first probe from a tag directory and the second request comprises a second probe from the tag directory.

Example 13 may include the subject matter of any of examples 7-12, wherein storing the reference to the second processor core comprises setting an order marker indicating that the second processor core is a next-in-line processor core for accessing the memory location.

Example 14 may include the subject matter of example 13, wherein determining, based on the data structure, that the third processor core is different from the second processor core comprises identifying the order marker and interpreting the order marker as an indication to process the second request for access to the memory location.

Example 15 is a system that includes a first core processor; a second processor core; a tag directory. The first processor core to make a request to the tag directory for data stored at a memory location; the tag directory to transmit a snoop message to the second processor core to request the data from the memory location; the second processor core to immediately respond to the snoop message with a response message that indicates that the second processor core does not have access to the data in the memory location.

Example 16 may include the subject matter of example 15, wherein the tag directory is configured to store a tag indicating that the second processor core has previously made a request for the data at the memory location, and is configured to send a snoop message to the second processor core based on the tag.

Example 17 may include the subject matter of any of examples 15-16, wherein the second processor core immediately responds to the snoop message directly to the first processor core.

Example 18 may include the subject matter of any of examples 15-17, wherein the tag directory is configured to respond to the request from the first processor with an order marker.

Example 19 may include the subject matter of example 18, wherein the first processor core is configured to receive the order marker and interpret the order marker as a handshake assigning the first processor core as a head-of-chain processor core.

Example 20 may include the subject matter of any of examples 15-19, further comprising a third processor core; wherein the tag directory is configured to send a snoop message to the third processor core; the third processor core to send the data to the first processor core.

Example 21 may include the subject matter of example 20, wherein the snoop message includes an invalidation request; the third processor core to invalidate the data in a cache of the third processor core after sending the data to the first processor core.

Example 22 may include the subject matter of any of examples 15-21, wherein the tag directory is to update a chain field with a reference to the second processor core.

Example 23 may include the subject matter of any of examples 15-22, wherein the second processor is to receive the snoop request for the data at the memory location; determine, based on a miss address file (MAF), that the second processor core is not a head-of-chain processor core; and based on not being head-of-chain, responding immediately to the snoop request without buffering the snoop request.

Example 24 may include the subject matter of any of examples 15-23, wherein the tag directory comprises a coarse bit, the coarse bit representing a plurality of processor cores.

Example 25 may include the subject matter of example 24, wherein the coarse bit represents the second processor core and a third processor core, the tag directory configured to send a snoop message to the second processor core and the third processor core based on the coarse bit.

Example 26 is an apparatus comprising means for requesting access to a memory address; means for storing an identification of the memory address in a data structure; means for receiving a first request for access to the memory address, the request comprising a reference to a second processor core; means for storing the reference to the second processor in the data structure; means for receiving a second request for access to the memory address, the second request comprising a reference to a third processor core; means for determining, based on the data structure, that the third processor core is different from the second processor core; and means for responding to the second request without buffering the second request.

Example 27 may include the subject matter of example 26, wherein means for responding to the second request comprises means for responding with one of a response invalid message (rspI) or response shared message (rspS).

Example 28 may include the subject matter of any of examples 26-27, wherein means for responding to the second request comprises means for transmitting a response message to a cache controller.

Example 29 may include the subject matter of any of examples 26-28, wherein the data structure comprises a miss address file (MAF).

Example 30 may include the subject matter of any of examples 26-29, wherein means for determining that the third processor core is different from the second processor core comprises means for comparing the reference to the second processor core in the data structure to the reference to the third processor core in the second request for access to the memory address.

Example 31 may include the subject matter of any of examples 26-30, wherein the first request comprises a first probe from a tag directory and the second request comprises a second probe from the tag directory.

Example 32 may include the subject matter of any of examples 26-31, wherein means for storing the reference to the second processor core comprises setting an order marker indicating that the second processor core is a next-in-line processor core for accessing the memory location.

Example 33 may include the subject matter of any of examples 26-32, wherein means for determining, based on the data structure, that the third processor core is different from the second processor core comprises means for identifying the order marker and interpreting the order marker as an indication to process the second request for access to the memory location.

Example 34 is a computer readable medium including code, when executed, to cause a machine to request access to a memory address; store an identification of the memory address in a data structure; receive a first request for access to the memory address, the request comprising a reference to a second processor core; store the reference to the second processor in the data structure; receive a second request for access to the memory address, the second request comprising a reference to a third processor core; determine, based on the data structure, that the third processor core is different from the second processor core; and respond to the second request without buffering the second request.

Example 35 may include the subject matter of example 34, wherein the code to respond to the second request comprises computer code to respond with one of a response invalid message (rspI) or response shared message (rspS).

Example 36 may include the subject matter of any of examples 34-35, wherein the code to respond to the second request comprises code to transmit a response message to the third processor core.

Example 37 may include the subject matter of any of examples 34-36, wherein the data structure comprises a miss address file (MAF).

Example 38 may include the subject matter of any of examples 34-37, wherein the code to determine that the third processor core is different from the second processor core comprises code to compare the reference to the second processor core in the data structure to the reference to the third processor core in the second request for access to the memory address.

Example 39 may include the subject matter of any of examples 34-38, wherein the first request comprises a first probe from a tag directory and the second request comprises a second probe from the tag directory.

Example 40 is a computer readable medium including code, when executed, to cause a machine to receive, at a first processor core, a request from a tag directory for access to a memory location; determine that the first processor core is not a head of chain processor core; and respond to the request from the tag directory without buffering the request, the response indicating that the first processor core does not have access to the memory location.

Example 41 may include the subject matter of example 40, wherein the code determines that the first processor core is not a head of chain processor core by performing a look up in an outstanding request buffer (ORB), wherein the ORB comprises a head-of-chain field, and wherein the head-of-chain field identifies a different processor core as head-of-chain.

Example 42 may include the subject matter of any of examples 40-41, wherein the request from the tag directory comprises a snoop message.

Example 43 may include the subject matter of any of examples 40-42, wherein the request comprises an invalidation request, and wherein code causes the machine to respond to the request by buffering the invalidation request and sending a response message directly to a second processor core, the second processor core identified in the request.

Example 44 may include the subject matter of any of examples 43, wherein the code causes the machine to service data at the memory address and invalidate the data at the memory address.

Example 45 may include the subject matter of any of examples 40-44, wherein the code when executed causes the machine to transmit, from a first processor core to a tag directory, a request for access to a memory location; receive, from the tag directory, a response comprising an order marker; and process the order marker to designate the first processor core as a head-of-chain processor core.

Example 46 may include the subject matter of any of examples 45, wherein code processes the order marker by deleting an indication of a head of chain associated with the memory location in an outstanding request buffer.

Example 47 may include the subject matter of any of examples 40-46, wherein responding to the request from the tag directory without buffering the request comprises immediately responding to the snoop by sending a response message to a processor core requesting access to the memory location.

What is claimed is:

1. A first processor core apparatus comprising:
logic circuitry to request access to a memory address;
logic circuitry to store an identification of the memory address in a data structure;
logic circuitry to receive a first request for access to the memory address, the request comprising a reference to a second processor core;
logic circuitry to store the reference to the second processor in the data structure;
logic circuitry to receive a second request for access to the memory address, the second request comprising a reference to a third processor core;
logic circuitry to determine, based on the data structure, that the third processor core is different from the second processor core; and
logic circuitry to respond to the second request without buffering the second request.

2. The first processor core apparatus of claim 1, wherein the logic circuitry to respond to the second request comprises logic circuitry to respond with one of a response invalid message (rspI) or response shared message (rspS).

3. The first processor core apparatus of claim 1, wherein the logic circuitry to respond to the second request comprises logic circuitry to transmit a response message to the third processor core.

4. The first processor core apparatus of claim 1, wherein the data structure comprises a miss address file (MAF).

5. The first processor core apparatus of claim 1, wherein the logic circuitry to determine that the third processor core is different from the second processor core comprises logic circuitry to compare the reference to the second processor core in the data structure to the reference to the third processor core in the second request for access to the memory address.

6. The first processor core apparatus of claim 1, wherein the first request comprises a first probe from a tag directory and the second request comprises a second probe from the tag directory.

7. A computer readable medium including code, when executed, to cause a machine to:
receive, at a first processor core, a request from a tag directory for access to a memory location;
determine that the first processor core is not a head of chain processor core; and
respond to the request from the tag directory without buffering the request, the response indicating that the first processor core does not have access to the memory location.

8. The computer readable medium of claim 7, wherein the code determines that the first processor core is not a head of chain processor core by performing a look up in an outstanding request buffer (ORB), wherein the ORB comprises a head-of-chain field, and wherein the head-of-chain field identifies a different processor core as head-of-chain.

9. The computer readable medium of claim 7, wherein the request from the tag directory comprises a snoop message.

10. The computer readable medium of claim 7, wherein the request comprises an invalidation request, and wherein code causes the machine to respond to the request by buffering the invalidation request and sending a response message directly to a second processor core, the second processor core identified in the request.

11. The computer readable medium of claim 10, wherein the code causes the machine to service data at the memory address and invalidate the data at the memory address.

12. The computer readable medium of claim 7, wherein the code when executed causes the machine to:
transmit, from a first processor core to a tag directory, a request for access to a memory location;
receive, from the tag directory, a response comprising an order marker;
process the order marker to designate the first processor core as a head-of-chain processor core.

13. The computer readable medium of claim 12, wherein code processes the order marker by deleting an indication of a head of chain associated with the memory location in an outstanding request buffer.

14. The computer readable medium of claim 7, wherein responding to the request from the tag directory without buffering the request comprises immediately responding to the snoop by sending a response message to a processor core requesting access to the memory location.

15. A system comprising:
a first core processor;
a second processor core;
a tag directory;
the first processor core to make a request to the tag directory for data stored at a memory location;
the tag directory to transmit a snoop message to the second processor core to request the data from the memory location;
the second processor core to immediately respond to the snoop message with a response message that indicates that the second processor core does not have access to the data in the memory location.

16. The system of claim 15, wherein the tag directory is configured to store a tag indicating that the second processor core has previously made a request for the data at the memory location, and is configured to send a snoop message to the second processor core based on the tag.

17. The system of claim 15, wherein the second processor core immediately responds to the snoop message directly to the first processor core.

18. The system of claim 15, wherein the tag directory is configured to respond to the request from the first processor with an order marker.

19. The system of claim 18, wherein the first processor core is configured to receive the order marker and interpret the order marker as a handshake assigning the first processor core as a head-of-chain processor core.

20. The system of claim 15, further comprising a third processor core;
wherein the tag directory is configured to send a snoop message to the third processor core;
the third processor core to send the data to the first processor core.

21. The system of claim 20, wherein the snoop message includes an invalidation request;
the third processor core to invalidate the data in a cache of the third processor core after sending the data to the first processor core.

22. The system of claim 15, wherein the tag directory is to update a chain field with a reference to the second processor core.

23. The system of claim 15, wherein the second processor is to:
receive the snoop request for the data at the memory location;
determine, based on a miss address file (MAF), that the second processor core is not a head-of-chain processor core; and
based on not being head-of-chain, responding immediately to the snoop request without buffering the snoop request.

24. The system of claim 15, wherein the tag directory comprises a coarse bit, the coarse bit representing a plurality of processor cores.

25. The system of claim 24, wherein the coarse bit represents the second processor core and a third processor core, the tag directory configured to send a snoop message to the second processor core and the third processor core based on the coarse bit.
